(19) United States
(12) Patent Application Publication
(10) Pub. No.: US 2025/0247008 A1
(43) Pub. Date: Jul. 31, 2025

(54) ACTIVE CLAMP FLYBACK CONVERTER WITH SAFE OPERATION

(71) Applicant: Chengdu Monolithic Power Systems Co., Ltd., Chengdu (CN)

(72) Inventor: Xiangyi Yang, Chengdu (CN)

(21) Appl. No.: 19/041,022

(22) Filed: Jan. 30, 2025

(30) Foreign Application Priority Data
Jan. 31, 2024 (CN) 202410143563.X

(51) Int. Cl. H02M 3/335; H02M 1/34

(52) U.S. Cl. CPC H02M 3/33569; H02M 1/342

(57) ABSTRACT

An active clamp flyback converter with safe operation is discussed. The active clamp flyback converter has a main power switch and an auxiliary switch integrated at a same IC chip. The active clamp flyback converter enables a first charge path from the power supply voltage to a floating capacitor when the main power switch is turned on. The first charge path is disabled and a second charge path from a second pin of the IC chip to the floating capacitor is enabled when a voltage at the second pin is higher than a reference voltage.

### CROSS-REFERENCE TO RELATED APPLICATIONS

This application claims priority to and the benefit of Chinese Patent Application No. 202410143563.X, filed Jan. 31, 2024, which is incorporated herein by reference in its entirety.

### BACKGROUND OF THE INVENTION

Active clamp flyback converters are widely used in galvanically isolated fields, because of the high efficiency and low EMI (electro-magnetic interference). The so-called active clamp flyback converter refers to a flyback converter that having an auxiliary switch and an absorb capacitor in the primary side besides the main power switch. As shown in FIG. 1, the active flyback converter comprises a main power switch S1 and an auxiliary switch S2, coupled to a primary winding T1 of a transformer T. The auxiliary switch S2 may be OFF during the ON duration of the main power switch S1 and may keep ON during the OFF duration of the main power switch S1, i.e., the two switches are turned on complementary. Alternatively, the auxiliary switch S2 may be OFF during the ON duration of the main power switch S1 and may be ON for a period of time during the OFF duration of the main power switch S1. When the main power switch S1 is turned off, an energy in the leakage inductance of the transformer T1 is transferred to an absorb capacitor C1. Because the auxiliary switch S2 is ON, the absorb capacitor C1 will reversely charge the leakage inductance after the current flowing through the primary side falls to zero. Thus, the energy absorbed by the absorb capacitor C1 is transferred to the leakage inductance and is released to the load, which improves the efficiency.

In the above active clamp flyback converter, the auxiliary switch S2 is a high side power switch, which has one terminal configured to receive an input voltage Vin via the absorb capacitor C1, and the other terminal coupled to the main power switch S1. Thus, floating drive (also known as bootstrap) is needed for the auxiliary switch S2, which lifts up a voltage level at a control terminal of the auxiliary switch S2.

However, the voltage across the absorb capacitor C1 may be lifted to a relatively high voltage value when charging for the floating drive of the auxiliary switch S2, which may cause a voltage at the common connection (i.e., the SNBR pin in FIG. 1) of the auxiliary switch S2 and the absorb capacitor C1 to exceed a sustained voltage of the IC pin, leading to an IC damage.

### SUMMARY OF THE INVENTION

In accordance with an embodiment of the present invention, an active clamp flyback converter is discussed. The active clamp flyback converter comprises: a transformer, including a primary winding configured to receive an input voltage, and a secondary winding configured to generate an output voltage. The active clamp flyback converter further comprises: an IC chip having: a first pin, a second pin, a third pin, and a fourth pin. The first pin is coupled to the primary winding, a main power switch, and an auxiliary switch. The second pin is configured to receive the input voltage via a buffer capacitor and is coupled to the first pin via the auxiliary switch. The third pin is coupled to the first pin via a floating capacitor. The fourth pin is configured to provide a power supply voltage to the IC chip. When the main power switch is turned on, a first charge path from the power supply voltage to the floating capacitor is enabled. When a voltage at the second pin is higher than a reference voltage, the main power switch is turned off, the first charge path is disabled, and a second charge path from the second pin to the floating capacitor is enabled.

In addition, in accordance with an embodiment of the present invention, an integrated circuit used for an active clamp flyback converter is discussed. The integrated circuit comprises: a first pin, a second pin, a third pin, and a fourth pin. The first pin is configured to receive an input voltage via a primary winding and is coupled to a main power switch, and an auxiliary switch. The second pin is configured to receive the input voltage via a buffer capacitor and is coupled to the first pin via the auxiliary switch. The third pin is coupled to the first pin via a floating capacitor. The fourth pin is configured to provide a power supply voltage to the IC chip. When the main power switch is turned on, a first charge path from the power supply voltage to the floating capacitor is enabled. When a voltage at the second pin is higher than a reference voltage, the main power switch is turned off, the first charge path is disabled, and a second charge path from the second pin to the floating capacitor is enabled.

Furthermore, in accordance with an embodiment of the present invention, an integrated circuit used for an active clamp flyback converter is discussed. The integrated circuit comprises: a first pin, a second pin, a third pin, and a fourth pin. The first pin is coupled to a main power switch, and an auxiliary switch. The second pin is coupled to the first pin via the auxiliary switch. The fourth pin is configured to provide a power supply voltage to the IC chip. When the main power switch is turned on, a first charge path from the power supply voltage to the third pin is enabled. When a voltage at the second pin is higher than a reference voltage, the main power switch is turned off, the first charge path is disabled, and a second charge path from the second pin to the third pin is enabled.

### BRIEF DESCRIPTION OF DRAWINGS

FIG. 1 schematically shows a typical active clamp flyback converter in the prior art.

FIG. 2 schematically shows a circuit configuration of an active clamp flyback converter 200 in accordance with an embodiment of the present invention.

FIG. 3 schematically shows a circuit configuration of an active clamp flyback converter 300 in accordance with an embodiment of the present invention.

FIG. 4 schematically shows a flowchart 400 of a method used in an active clamp flyback converter in accordance with an embodiment of the present invention.

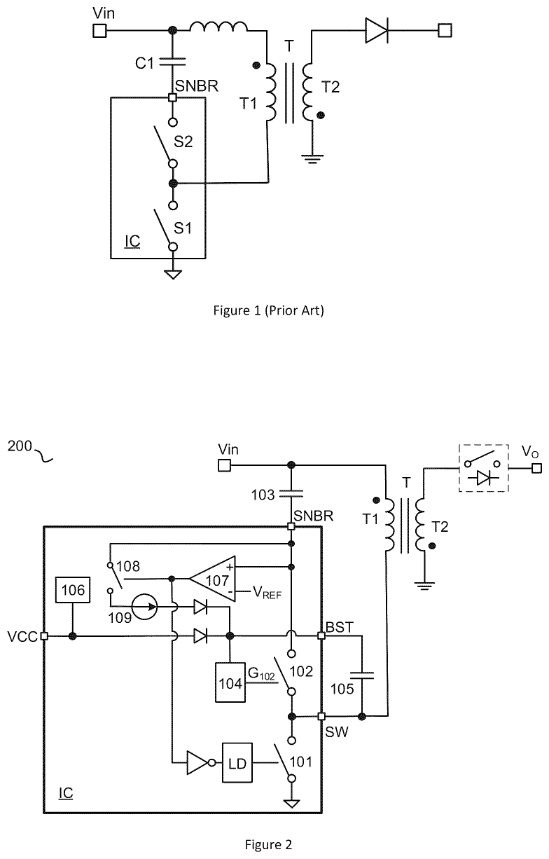

### DETAILED DESCRIPTION OF THE INVENTION

Embodiments of circuits for active clamp flyback converter are described in detail herein. In the following description, some specific details, such as example circuits for these circuit components, are included to provide a thorough understanding of embodiments of the invention. One skilled in relevant art will recognize, however, that the invention can be practiced without one or more specific details, or with other methods, components, materials, etc.

The following embodiments and aspects are illustrated in conjunction with circuits and methods that are meant to be exemplary and illustrative. In various embodiments, the above problem has been reduced or eliminated, while other embodiments are directed to other improvements.

FIG. 2 schematically shows a circuit configuration of an active clamp flyback converter 200 in accordance with an embodiment of the present invention. In the example of FIG. 2, the active clamp flyback converter 200 comprises: a transformer T, configured to receive an input voltage VIN. The transformer T includes a primary winding T1 and a secondary winding T2. The active clamp flyback converter 200 is configured to provide an output voltage Vo at the secondary winding T2. The active clamp flyback converter 200 further comprises: an IC (integrated circuit) chip having: a first pin SW (also known as a switch pin), a second pin SNBR, a third pin BST, and a fourth pin VCC (also known as a power supply pin). The first pin SW is coupled to the primary winding T1, a main power switch 101, and an auxiliary switch 102. The second pin SNBR is configured to receive the input voltage Vin via a buffer capacitor 103. The auxiliary switch 102 is coupled between the first pin SW and the second pin SNBR. The third pin BST is coupled to a first driver 104, which is configured to provide a drive signal G102 to the auxiliary switch 102. A floating capacitor 105 is coupled between the first pin SW and the third pin BST. The fourth pin VCC is configured to provide a power supply voltage to the IC chip. When the main power switch 101 is turned on, the power supply voltage, the floating capacitor 105, and the main power switch 101 form a current loop. Accordingly, the floating capacitor 105 is charged by the power supply voltage.

In the example of FIG. 2, the active clamp flyback converter 200 further comprises: a synchronous rectifier (or a rectifier diode), coupled to the secondary winding T2, to provide the output voltage Vₒ.

In one embodiment of the present invention, the main power switch 101 is coupled between the first pin SW and a reference ground.

In one embodiment of the present invention, the IC chip further comprises: a voltage converter 106 coupled to the fourth pin VCC, to provide the power supply voltage.

In the example of FIG. 2, the IC chip further comprises: a compare circuit 107, configured to compare a voltage at the second pin SNBR with a reference voltage V_{REF}. When the voltage at the second pin SNBR is higher than the reference voltage V_{REF}, the main power switch 101 is turned off, and a first charge path from the power supply voltage to the floating capacitor 105 is turned off (i.e., disabled). Meantime, a second charge path from the second pin SNBR to the floating capacitor 105 is turned on (i.e., enabled). As shown in FIG. 2, the IC chip further comprises: a connecting switch 108, coupled between the second pin SNBR and the third pin BST. When the voltage at the second pin SNBR is higher than the reference voltage V_{REF}, the connecting switch 108 is turned on. Accordingly, the buffer capacitor 103, the connecting switch 108, the floating capacitor 105 and the primary winding T1 form a current loop. The electric charge at the buffer capacitor 103 is transferred to the floating capacitor 105.

In one embodiment of the present invention, the floating capacitor 105 is charged by the voltage at the second pin SNBR via a current source 109. That is, the IC chip further comprises: a current source 109, series coupled with the connecting switch 108 between the second pin SNBR and the third pin BST.

In the example of FIG. 2, the IC chip further comprises: a second driver LD, configured to provide a drive signal to the main power switch 101. When the voltage at the second pin SNBR is higher than the reference voltage V_{REF}, the output of the compare circuit 107 is delivered to the second drive LD by way of an inverter, to turn off the main power switch 101.

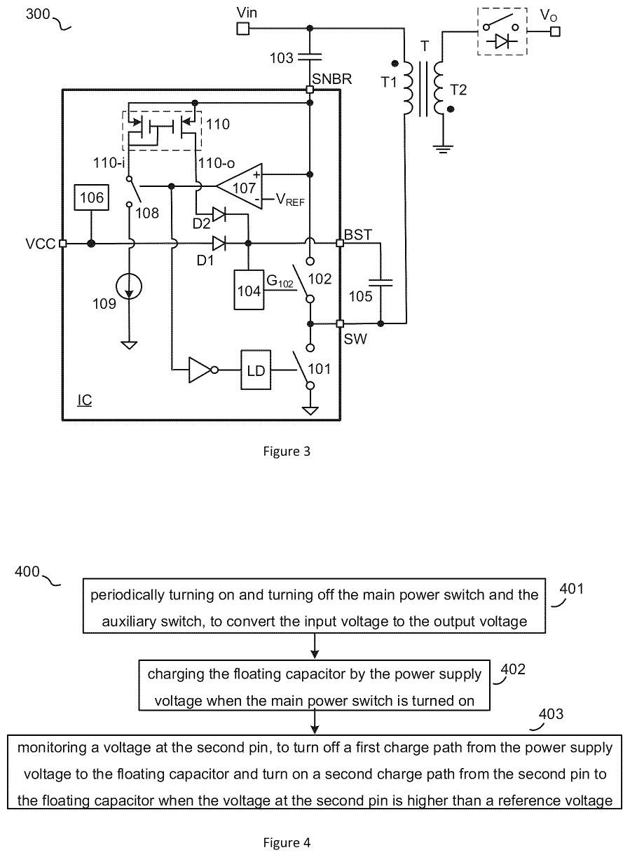

FIG. 3 schematically shows a circuit configuration of an active clamp flyback converter 300 in accordance with an embodiment of the present invention. The embodiment in FIG. 3 specifically shows the charge path from the voltage at the second pin SNBR to the floating capacitor 105 when the voltage at the second pin SNBR is higher than the reference voltage V_{REF}. As shown in FIG. 3, the IC chip further comprises: a current mirror circuit 110, configured to deliver a current signal provided by the current source 109 to the floating capacitor 105 when the connecting switch 108 is turned on. Specifically, the current mirror circuit 110 having an input terminal 110-i coupled to the current source 109, and an output terminal 110-o configured to provide a mirrored current proportional to the current signal provided by the current source 109 during the ON time of the connecting switch 108, to charge the floating capacitor 105.

In one embodiment of the present invention, a diode D1 is coupled between the power supply pin VCC and the floating capacitor 105, and a diode D2 is coupled between the second pin SNBR and the floating capacitor 105, to prevent a reverse leakage of the floating capacitor 105.

FIG. 4 schematically shows a flowchart 400 of a method used in an active clamp flyback converter in accordance with an embodiment of the present invention. The active clamp flyback converter comprises: a primary winding configured to receive an input voltage, a secondary winding configured to provide an output voltage, and an IC chip coupled to the primary winding. The IC chip comprises: a first pin, a second pin, a third pin, and a fourth pin. The first pin is coupled to the primary winding, a main power switch, and an auxiliary switch. The second pin is configured to receive the input voltage via a buffer capacitor. The auxiliary switch is coupled between the first pin and the second pin. The third pin is coupled to the first pin via a floating capacitor. The fourth pin is configured to provide a power supply voltage to the IC chip. The method comprises:

Step 401, periodically turning on and turning off the main power switch and the auxiliary switch, to convert the input voltage to the output voltage.

Step 402, charging the floating capacitor by the power supply voltage when the main power switch is turned on. and

Step 403, monitoring a voltage at the second pin, to turn off (i.e., disable) a first charge path from the power supply voltage to the floating capacitor and turn on (i.e. enable) a second charge path from the second pin to the floating capacitor when the voltage at the second pin is higher than a reference voltage.

In one embodiment of the present invention, the floating capacitor is charged by the voltage at the second pin via a current source.

Several embodiments of the foregoing active clamp flyback converter and the IC chip enable a second path from the common connection of the buffer capacitor and the IC chip to the floating capacitor when the voltage at the common connection is high, to transfer the electric charge from the buffer capacitor to the floating capacitor, which ensures the safe operation of the IC chip, and highly harvests the energy. Thus, the operation safety and the efficiency are highly improved.

It is to be understood in these letters patent that the meaning of “A” is coupled to “B” is that either A and B are connected to each other as described below, or that, although A and B may not be connected to each other as described above, there is nevertheless a device or circuit that is connected to both A and B. This device or circuit may include active or passive circuit elements, where the passive circuit elements may be distributed or lumped-parameter in nature. For example, A may be connected to a circuit element that in turn is connected to B.

This written description uses examples to disclose the invention, including the best mode, and also to enable a person skilled in the art to make and use the invention. The patentable scope of the invention may include other examples that occur to those skilled in the art.

1. An active clamp flyback converter, comprising:
a transformer, including a primary winding configured to receive an input voltage, and a secondary winding configured to generate an output voltage; and
an IC chip, having:
a first pin, coupled to the primary winding, a main power switch, and an auxiliary switch;
a second pin, a) configured to receive the input voltage via a buffer capacitor, and b) coupled to the first pin via the auxiliary switch;
a third pin, coupled to the first pin via a floating capacitor; and
a fourth pin, configured to provide a power supply voltage to the IC chip; wherein:
when the main power switch is turned on, a first charge path from the power supply voltage to the floating capacitor is enabled; and
when a voltage at the second pin is higher than a reference voltage, the main power switch is turned off, the first charge path is disabled, and a second charge path from the second pin to the floating capacitor is enabled.

2. The active clamp flyback converter of claim 1, wherein the IC chip further comprises:
a connecting switch, coupled between the second pin and the third pin, wherein the connecting switch is configured to be turned on when the voltage at the second pin is higher than the reference voltage.

3. The active clamp flyback converter of claim 2, wherein the IC chip further comprises:
a current source, series coupled with the connecting switch between the second pin and the third pin.

4. The active clamp flyback converter of claim 2, wherein the IC chip further comprises:
a current source, configured to provide a current signal; and
a current mirror circuit, configured to deliver the current signal to the floating capacitor when the connecting switch is turned on.

5. The active clamp flyback converter of claim 4, wherein:
the current mirror circuit having an input terminal coupled to the current source, and an output terminal configured to provide a mirrored current proportional to the current signal when the connect switch is turned on, to charge the floating capacitor.

6. The active clamp flyback converter of claim 1, wherein the IC chip further comprises:
a voltage converter, coupled to the fourth pin, to provide the power supply voltage.

7. An IC chip used in an active clamp flyback converter, comprising:
a first pin, a) configured to receive an input voltage via a primary winding, and b) coupled to a main power switch and an auxiliary switch;
a second pin, a) configured to receive the input voltage via a buffer capacitor, and b) coupled to the first pin via the auxiliary switch;
a third pin, coupled to the first pin via a floating capacitor; and
a fourth pin, configured to provide a power supply voltage to the IC chip; wherein:
when the main power switch is turned on, a first charge path from the power supply voltage to the floating capacitor is enabled; and
when a voltage at the second pin is higher than a reference voltage, the main power switch is turned off, the first charge path is disabled, and a second charge path from the second pin to the floating capacitor is enabled.

8. The IC chip of claim 7, further comprising:
a connecting switch, coupled between the second pin and the third pin, wherein the connecting switch is configured to be turned on when the voltage at the second pin is higher than the reference voltage.

9. The IC chip of claim 8, further comprising:
a current source, series coupled with the connecting switch between the second pin and the third pin.

10. The IC chip of claim 8, further comprising:
a current source, configured to provide a current signal; and
a current mirror circuit, configured to deliver the current signal to the floating capacitor when the connecting switch is turned on.

11. The IC chip of claim 10, wherein:
the current mirror circuit having an input terminal coupled to the current source, and an output terminal configured to provide a mirrored current proportional to the current signal when the connect switch is turned on, to charge the floating capacitor.

12. The IC chip of claim 7, further comprising:
a voltage converter, coupled to the fourth pin, to provide the power supply voltage.

13. An IC chip used in an active clamp flyback converter, comprising:
a first pin, coupled to a main power switch and an auxiliary switch;
a second pin, coupled to the first pin via the auxiliary switch;
a third pin; and
a fourth pin, configured to provide a power supply voltage to the IC chip; wherein:
when the main power switch is turned on, a first charge path from the power supply voltage to the third pin is enabled; and
when a voltage at the second pin is higher than a reference voltage, the main power switch is turned off, the first charge path is disabled, and a second charge path from the second pin to the third pin is enabled.

14. The IC chip of claim 13, further comprising:
a connecting switch, coupled between the second pin and the third pin, wherein the connecting switch is configured to be turned on when the voltage at the second pin is higher than the reference voltage.

15. The IC chip of claim 14, further comprising:
a current source, series coupled with the connecting switch between the second pin and the third pin.

16. The IC chip of claim 14, further comprising:
a current source, configured to provide a current signal; and
a current mirror circuit, configured to deliver the current signal to the third pin when the connecting switch is turned on.

17. The IC chip of claim 16, wherein:
the current mirror circuit having an input terminal coupled to the current source, and an output terminal configured to provide a mirrored current proportional to the current signal when the connect switch is turned on.

18. The IC chip of claim 13, wherein:
a floating capacitor is coupled between the first pin and the third pin.

19. The IC chip of claim 13, wherein:
the second pin is configured to receive an input voltage via a buffer capacitor.

20. The IC chip of claim 13, further comprising:
a voltage converter, coupled to the fourth pin, to provide the power supply voltage.
